(19) United States
(12) Patent Application Publication
(10) Pub. No.: US 2026/0261036 A1
(43) Pub. Date: Sep. 3, 2026

(54) ANTENNA APPARATUS AND BASE STATION ANTENNA SYSTEM

(71) Applicant: HUAWEI TECHNOLOGIES CO., LTD., Shenzhen (CN)

(72) Inventors: Li Jin, Xi'an (CN); Shaobo Ma, Xi'an (CN); Xingang Yu, Xi'an (CN); Enpu Wang, Xi'an (CN); Xiaoqiang Hou, Shanghai (CN)

(21) Appl. No.: 19/658,838

(22) Filed: Apr. 27, 2026

Related U.S. Application Data
(63) Continuation of application No. PCT/CN2024/126639, filed on Oct. 23, 2024.

(30) Foreign Application Priority Data
Oct. 27, 2023 (CN) 202311408762.0

(51) Int. Cl. H01Q 1/24; H01Q 15/24; H01Q 19/10

(52) U.S. Cl. CPC H01Q 1/246; H01Q 15/24; H01Q 19/10

(57) ABSTRACT

This application provides an antenna apparatus and a base station antenna system. The antenna apparatus includes a reflection panel, a radiating element, and a feed network. A first aperture is provided on the reflection panel. The radiating element includes a radiator and a feed stub, and the radiator is coupled to the feed stub. The radiator is disposed on one side of the reflection panel and is spaced apart from the reflection panel. At least a portion of the feed stub passes through the first aperture. The feed network is disposed on a side, facing away from the radiating element, of the reflection panel and is spaced apart from the reflection panel. The feed network is coupled to the feed stub. This simplifies a structure of the antenna apparatus, reduces a quantity of components, reduces a weight, and facilitates overall assembly of the antenna apparatus.

### CROSS-REFERENCE TO RELATED APPLICATIONS

This application is a continuation of International Application No. PCT/CN2024/126639, filed on Oct. 23, 2024, which claims priority to Chinese Patent Application No. 202311408762.0, filed on Oct. 27, 2023. The disclosures of the aforementioned applications are hereby incorporated by reference in their entireties.

### TECHNICAL FIELD

This application relates to the field of communication technologies, and in particular, to an antenna apparatus and a base station antenna system.

### BACKGROUND

With device development and technological progress, the requirements for higher antenna gain and multi-band coexistence are becoming increasingly stringent. Therefore, there is a need for a plurality of radiating elements to form arrays, resulting in a large quantity of elements. In addition, to maintain performance of a feed network, a quantity of ports needs to be increased accordingly, bringing challenges in design of the feed network. Conventionally, coaxial cables are used as a main transmission medium, leading to high complexity of assembly, a large quantity of solder joints, a large quantity of cables, limited space on a rear side, and difficulty in operations.

### SUMMARY

In view of this, this application provides an antenna apparatus and a base station antenna system, which simplify a structure of a feed network and reduce a quantity of antenna components, thereby enabling faster and more convenient production and assembly.

According to a first aspect, an embodiment of this application provides an antenna apparatus, including:
a reflection panel, where a first aperture is provided on the reflection panel;
a radiating element, where the radiating element includes a radiator and a feed stub, the radiator is coupled to the feed stub, the radiator is disposed on one side of the reflection panel and is spaced apart from the reflection panel, and at least a portion of the feed stub passes through the first aperture; and
a feed network, disposed on a side, facing away from the radiating element, of the reflection panel and spaced apart from the reflection panel, where the feed network is coupled to the feed stub.

In this application, the radiator located on one side of the reflection panel passes through the first aperture on the reflection panel by using the feed stub and then is coupled to the feed network located on the other side of the reflection panel. This simplifies a structure of the antenna apparatus, reduces a quantity of components, reduces a weight, and facilitates overall assembly of the antenna apparatus.

In a possible implementation, the antenna apparatus further includes a metal cavity, the reflection panel is a top wall of the metal cavity, and the feed network is disposed in the metal cavity.

In a possible implementation, the antenna apparatus further includes a bottom wall, a first side wall, and a second side wall, and the reflection panel, the first side wall, the bottom wall, and the second side wall are sequentially coupled head to tail, and enclose the metal cavity. The metal cavity can reduce energy loss. This helps transfer energy to the radiating element through the metal cavity, to improve radiation performance, and also helps affect resonance distribution of the feed network, to improve transmission characteristics of the feed network. In addition, the reflection panel may serve as a side wall of the metal cavity. In this way, radio frequency signals can be converged to a convergence point of the radiating element, to improve reception sensitivity for the radio frequency signals, and energy of the feed network can be constrained by the formed metal cavity, to avoid energy leakage and loss and improve energy transfer quality.

In a possible implementation, at least portions of the following are welded: the reflection panel, the first side wall, the bottom wall, and the second side wall. Through welding, reliability of a connection between two welded mechanical parts can be ensured.

In a possible implementation, at least portions of the following are connected through a connecting piece: the reflection panel, the first side wall, the bottom wall, and the second side wall, with coupling gaps defined therebetween. Portions of adjacent components may be connected through a screw or a rivet, with a preset gap retained, to simplify a process and facilitate assembly.

In a possible implementation, the feed network includes at least two feed sheets, at least two feed stubs are disposed, the radiator generates one polarization through at least one feed stub, and the radiator generates another polarization through at least another feed stub. The feed stub that enables the radiator to generate the one polarization is coupled to one of the feed sheets, and the feed stub that enables the radiator to generate the another polarization is coupled to another one of the feed sheets. Feeding phases of the two feed stubs are different, so that the radiator can generate dual polarizations. Directions of the two polarizations may be perpendicular to each other. To be specific, one polarization is a −45° polarization, and the other polarization is a +45° polarization. In this way, a dual-polarized antenna is formed.

In a possible implementation, the antenna apparatus further includes an isolated ground. The isolated ground is disposed in the metal cavity, and two ends of the isolated ground are respectively coupled to the reflection panel and the bottom wall. The metal cavity is divided into a first cavity and a second cavity by the isolated ground. A feed sheet that enables the radiating element to generate one polarization is located in the first cavity, and a feed sheet that enables the radiating element to generate another polarization is located in the second cavity. The isolated ground is made of a metal material, to implement good isolation between the dual polarizations, and ensure that the antenna apparatus achieves good radiation performance.

In a possible implementation, the isolated ground, the bottom wall, the first side wall, and the second side wall are integrally formed, and there is a coupling gap between the reflection panel and an end, away from the bottom wall, of the isolated ground, to ensure reliability of connections between the isolated ground, the bottom wall, the first side wall, and the second side wall.

In a possible implementation, there are coupling gaps between the two ends of the isolated ground and the reflection panel and the bottom wall respectively. If the isolated ground is directly connected to the bottom wall or the reflection panel, a new frequency component is likely to appear due to poor contact between metals, causing interference and reception blocking. Therefore, in this embodiment, the isolated ground may be separately processed, manufactured, and assembled. During assembly, the isolated ground may be fastened to each of the reflection panel and the bottom wall through a connecting piece like a screw or a rivet, and a preset gap can be retained between the isolated ground and each of the reflection panel and the bottom wall through the connecting piece like the screw or the rivet, to form a gap coupling connection, to avoid direct contact between metals, and ensure normal operation of the antenna apparatus.

In a possible implementation, a coupling gap between the isolated ground and the reflection panel and/or a coupling gap between the isolated ground and the bottom wall are/is less than 1 mm, to ensure effective energy transfer between the isolated ground and the reflection panel and/or between the isolated ground and the bottom wall, and reduce loss.

In a possible implementation, four feed stubs are disposed, the four feed stubs are respectively distributed in four corners of a rhombus pattern, two feed stubs located on one diagonal line are coupled to one of the feed sheets, and two feed stubs located on the other diagonal line are coupled to another one of the feed sheets. Two feed stubs located on one diagonal line may enable the radiator to generate one polarization, and two feed stubs located on the other diagonal line may enable the radiator to generate another polarization. With the four feed stubs disposed, higher bandwidth can be achieved.

In a possible implementation, the feed network is provided with a second aperture, and the feed stub passes through the second aperture.

In a possible implementation, there is a coupling gap between the feed stub and the second aperture. For example, the feed stub may be welded to an inner wall of the second aperture, to implement feeding through a direct electrical connection. For example, there may alternatively be a coupling gap between the feed stub and an inner wall of the second aperture. During assembly, the feed stub only needs to sequentially pass through the first aperture of the reflection panel and the second aperture of the feed network, and the feed stub does not need to be directly connected to the feed network through a cable, a welding process, or the like. This simplifies an assembly operation, and also helps reduce a quantity of components, improve integration of the antenna apparatus, and implement a lightweight design of the antenna apparatus.

In a possible implementation, the radiator and the feed stub are integrally formed, to ensure reliability of a connection between the radiator and the feed stub, facilitate assembly, and reduce an assembly tolerance.

In a possible implementation, a slot is provided on the radiator, the feed stub is coupled to the slot, and there is a coupling gap between the feed stub and an inner wall of the slot. Compared with a design in which the radiator and the feed stub are integrally formed, gap-coupling the feed stub to the slot on the radiator can achieve higher bandwidth. In addition, a new resonance point can be further introduced, to provide more operating modes.

In a possible implementation, there is a gap between the feed stub and the first aperture. There is a gap between the feed stub and the first aperture, so that a short circuit can be avoided, and the feed network and the radiator that are located on two sides of the reflection panel can be electrically coupled after the feed stub passes through the first aperture. This helps improve compactness of a structure of the antenna apparatus, and facilitates assembly.

In a possible implementation, the antenna apparatus further includes a parasitic stub, and the parasitic stub is coupled to the radiator. The parasitic stub may alternatively include a metal sheet, and there is a specific spacing between the parasitic stub and the radiator. The parasitic stub can improve radiation performance of the radiator and increase bandwidth, and can also introduce new resonance, to provide more operating modes.

In a possible implementation, the antenna apparatus further includes a support, the feed network is connected to the support, a third aperture is provided on the reflection panel, and at least a portion of the support passes through the third aperture and is connected to the radiator. The design of the support can facilitate assembly of the feed network and the radiating element, and can also ensure reliability of an overall structure of the antenna apparatus. In addition, the third aperture is provided on the reflection panel, so that at least a portion of the support can pass through the third aperture, and some parts of the support that are located on the two sides of the reflection panel can be respectively connected to the feed network and the radiator. In this way, both the feed network and the radiator are supported and fastened by the support. This facilitates an assembly operation, simplifies an overall structure of the antenna apparatus, and facilitates a lightweight and miniaturization design of the antenna apparatus.

According to a second aspect, this application further provides a base station antenna system, including the antenna apparatus provided in the first aspect of this application. The base station antenna system including the antenna apparatus has technical effects similar to those of the antenna apparatus. Details are not described herein again.

It should be understood that the foregoing general descriptions and the following detailed descriptions are merely examples, and are not intended to limit this application.

### BRIEF DESCRIPTION OF DRAWINGS

To describe technical solutions in embodiments of this application more clearly, the following briefly describes accompanying drawings used in embodiments. Clearly, the accompanying drawings in the following descriptions show merely some embodiments of this application, and a person of ordinary skill in the art may still derive other drawings from these accompanying drawings without creative efforts.

FIG. 1 is a diagram of a structure of a base station antenna system according to an embodiment of this application;

FIG. 2 is a diagram of a structure of an antenna apparatus according to a first embodiment of this application;

FIG. 3 is a side view of an antenna apparatus according to a first embodiment of this application;

FIG. 4 is a partial diagram of an antenna apparatus (a support is hidden) according to a first embodiment of this application;

FIG. 5 is a partial diagram of an antenna apparatus (a support and a reflection panel are hidden) according to a first embodiment of this application;

FIG. 6 is an enlarged view of a position A in FIG. 5;

FIG. 7 is a diagram of a structure of an antenna apparatus according to a second embodiment of this application;

FIG. 8 is a side view of an antenna apparatus according to a second embodiment of this application;

FIG. 9 is a diagram of a connection between a radiator and feed stubs according to a first embodiment of this application;

FIG. 10 is a diagram of a structure of an antenna apparatus according to a third embodiment of this application;

FIG. 11 is a partial diagram of an antenna apparatus (a support and a reflection panel are hidden) according to a third embodiment of this application;

FIG. 12 is a diagram of a connection between a radiator and feed stubs according to a third embodiment of this application; and

FIG. 13 is a diagram of a connection between a radiator and feed stubs according to a fourth embodiment of this application.

### REFERENCE NUMERALS

100: antenna apparatus;
200: downtilt arm;
300: mounting pole;
400: feeder;
500: fixture;
600: remote radio unit;
1: reflection panel;
11: first aperture;
12: third aperture;
2: radiating element;
21: radiator;
211: slot;
22: feed stub;
23: parasitic stub;
3: feed network;
31: feed sheet;
311: second aperture;
4: support;
5: metal cavity;
51: bottom wall;
52: first side wall;
53: second side wall;
54: isolated ground;
55: first cavity;
56: second cavity.

### Description of Embodiments

For ease of understanding technical solutions of this application, the following describes embodiments of this application in detail with reference to the accompanying drawings.

It should be noted that the described embodiments are merely some but not all of embodiments of this application. All other embodiments obtained by a person of ordinary skill in the art based on embodiments of this application without creative efforts shall fall within the protection scope of this application.

Terms used in embodiments of this application are merely intended to describe specific embodiments, but not to limit this application. The terms “a”, “the”, and “this” of singular forms used in embodiments of this application and the appended claims are also intended to include plural forms, unless otherwise specified in the context clearly.

It should be understood that the term “and/or” used in this specification describes only an association relationship between associated objects, and indicates that three relationships may exist. For example, A and/or B may indicate the following three cases: Only A exists, both A and B exist, and only B exists. In addition, the character “/” in this specification usually indicates an “or” relationship between the associated objects.

In descriptions of this application, unless otherwise clearly specified and limited, the terms “first” and “second” are merely intended for description, and shall not be understood as an indication or implication of relative importance. Unless otherwise specified or stated, the term “a plurality of” means two or more. The terms “connection”, “fastening”, and the like should be understood in a broad sense. For example, the “connection” may be fastening, a detachable connection, an integrated connection, or an electrical connection, or may be a direct connection or an indirect connection through an intermediate medium. A person of ordinary skill in the art may understand specific meanings of the foregoing terms in this application based on a specific case.

Coupling may be understood as direct coupling and/or indirect coupling. A “coupling connection” may be understood as a direct coupling connection and/or an indirect coupling connection. The direct coupling may also be referred to as an “electrical connection”, and may be understood as physical contact and electrical conduction between components, or may be understood as a form in which different components in a line structure are connected through a physical line that can transmit an electrical signal, for example, a copper foil or a conducting wire of a printed circuit board (printed circuit board, PCB). The “indirect coupling” may be understood as electrical conduction between two conductors through air or without contact. In an embodiment, the indirect coupling may also be referred to as capacitive coupling. For example, signal transmission is implemented by forming an equivalent capacitor through coupling in a gap between two electric-conductors that are spaced apart.

A radiator is an apparatus for receiving/sending electromagnetic wave radiation in an antenna. In some cases, an “antenna” is understood as a radiator in a narrow sense. The radiator converts guided wave energy from a transmitter into a radio wave, or converts a radio wave into guided wave energy, to radiate and receive a radio wave. Modulated high-frequency current energy (or guided wave energy) generated by the transmitter is transmitted to a transmit radiator through a feeder. The radiator converts the modulated high-frequency current energy into specific polarized electromagnetic wave energy, and radiates the electromagnetic wave energy in a needed direction. A receive radiator converts specific polarized electromagnetic wave energy from a specific direction of space into modulated high-frequency current energy, and transmits the modulated high-frequency current energy to an input end of a receiver through a feeder.

The radiator may be a conductor with a specific shape and size, for example, a wire antenna. The wire antenna is an antenna including one or more metal conducting wires whose diameter is much less than a wavelength and whose length is comparable to the wavelength, and may serve as a transmit antenna or a receive antenna. Main forms of the wire antenna include a dipole antenna, a half-wave element antenna, a monopole antenna, a loop antenna, an inverted F antenna (also referred to as an IFA, Inverted F Antenna), a planar inverted F antenna (also referred to as a PIFA, Planar Inverted F Antenna), a slot antenna or a slit antenna, an antenna array, and the like. For example, for the dipole antenna, each dipole antenna usually includes two radiation stubs, and each stub is fed by a feeding part from a feeding end of the radiation stub. For example, the slot antenna or the slit antenna may include a single radiation stub, and two ends of the stub are grounded to form a slot or a slit.

The radiator may alternatively be a slot or a slit formed on a conductor. For example, an antenna formed through slotting on a conductor surface may also be referred to as a slot antenna or a slotted antenna. In some embodiments, the slot is in a long strip shape. In some embodiments, a length of the slot is approximately half of a wavelength. In some embodiments, the slot may be fed by a transmission line that is bridge-connected to one or two sides of the slot, or may be fed by a waveguide or a resonant cavity. A radio frequency electromagnetic field is excited on the slot, and an electromagnetic wave is radiated to space.

To meet requirements for an antenna gain and multi-frequency coexistence, a plurality of radiating elements usually form an array. Due to a large quantity of elements, to keep performance of a feed network unchanged, a quantity of ports also needs to be increased correspondingly. Consequently, a design of the feed network is more complex. Conventionally, a coaxial cable is used as a main transmission medium, leading to high complexity of assembly, a large quantity of solder joints, a large quantity of cables, limited space on a rear side of an antenna, and difficulty in an assembly operation of the feed network.

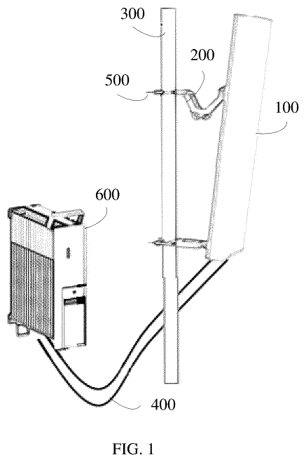

FIG. 1 is a diagram of a structure of a base station antenna system according to an embodiment of this application. As shown in FIG. 1, an embodiment of this application provides an antenna apparatus. The antenna apparatus may be used in the base station antenna system. The base station antenna system and the antenna apparatus 100 may be used in the fields of radars, broadcasting, communication, and the like. The base station antenna system may include a downtilt arm 200, a mounting pole 300, a feeder 400, a fixture 500, a remote radio unit 600 (full name: Remote Radio Unit, RRU), the antenna apparatus 100, and the like. The antenna apparatus 100 may be fastened to the mounting pole 300 through the fixture 500. The antenna apparatus 100 may be connected to the remote radio unit 600 through the feeder 400. The downtilt arm 200 may be used to adjust a downtilt angle of the antenna apparatus 100. The base station antenna system is an interface device for wireless communication, and can exchange information with a communication terminal in an area in which the base station antenna system is located.

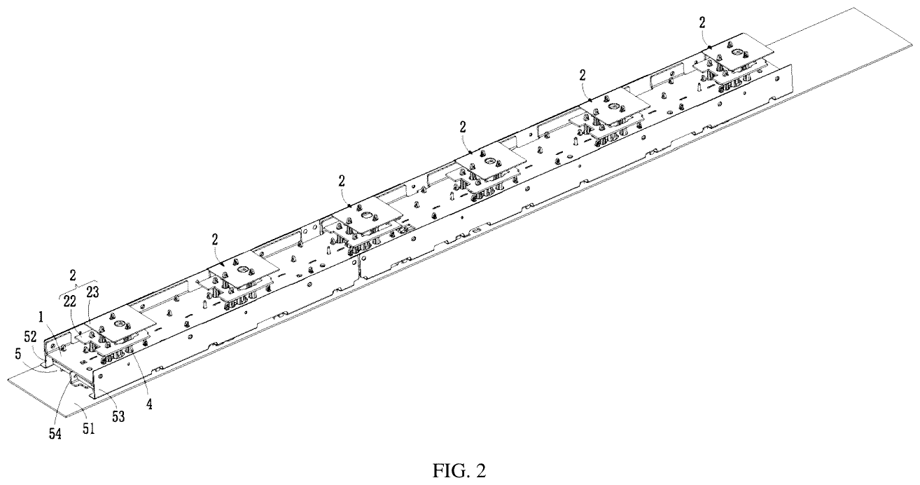

In an embodiment, FIG. 2 is a diagram of a structure of an antenna apparatus 100 according to a first embodiment of this application. As shown in FIG. 2, the antenna apparatus 100 includes a reflection panel 1, a radiating element 2, and a feed network 3. The reflection panel 1 can converge radio frequency signals to a convergence point of the radiating element 2, to improve reception sensitivity for the radio frequency signals, and block an interference radio wave below the reflection panel 1. The radiating element 2 includes a radiator 21, and can transmit or receive a radio frequency signal through the radiator 21. The radiating element 2 further includes a feed stub 22. The radiator 21 is coupled to the feed stub 22, and the feed stub 22 is coupled to the feed network 3. The feed network 3 may feed the radiator 21 through the feed stub 22, to enable the radiator 21 to transmit or receive a radio frequency signal.

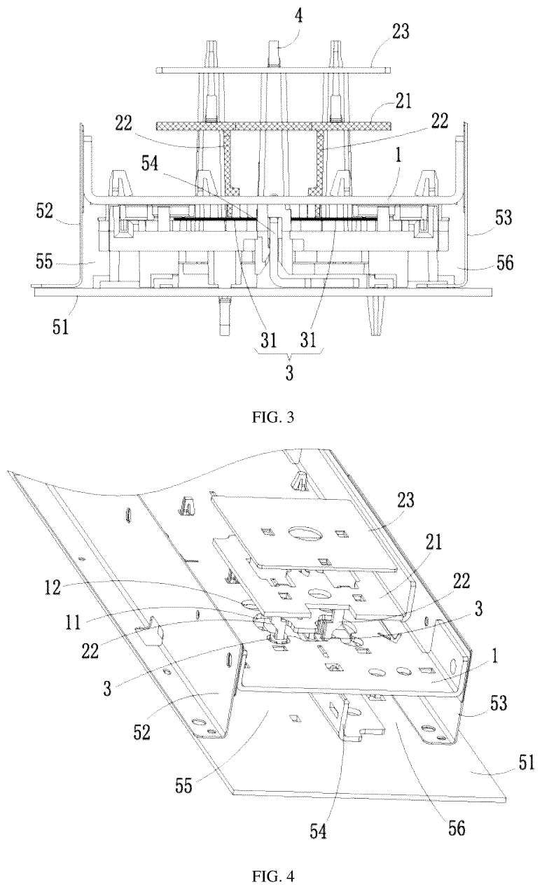

FIG. 3 is a side view of the antenna apparatus 100 according to the first embodiment of this application. As shown in FIG. 3, the radiator 21 is disposed on one side of the reflection panel 1 and is spaced apart from the reflection panel 1. The feed network 3 is disposed on a side, facing away from the radiating element 2, of the reflection panel 1 and is spaced apart from the reflection panel 1. FIG. 4 is a partial diagram of the antenna apparatus 100 (a support 4 is hidden) according to the first embodiment of this application. As shown in FIG. 4, a first aperture 11 is provided on the reflection panel 1, and at least a portion of the feed stub 22 passes through the first aperture 11. To be specific, a middle area of the feed stub 22 may pass through the first aperture 11 on the reflection panel 1, and two ends of the feed stub 22 may be respectively coupled to the radiator 21 and the feed network 3 on two sides of the reflection panel 1.

The feed network 3 may be entirely disposed on one side of the reflection panel 1, and may be coupled to the feed stub 22 to feed the radiator 21, without using a plurality of mechanical parts such as coaxial cables. This simplifies an overall structure of the feed network 3, reduces a weight, and facilitates overall assembly of the antenna apparatus 100.

In an embodiment, as shown in FIG. 2, there may be a plurality of radiating elements 2, all of the plurality of radiating elements 2 may be fed by one feed network 3, and different radiating elements 2 do not need to be respectively fed through a plurality of coaxial cables. This greatly simplifies a structure of the antenna apparatus 100.

As described above, the feed stub 22 is coupled to the feed network 3. For example, the feed stub 22 may be directly electrically connected, for example, welded, to the feed network 3, to ensure reliability of an electrical connection between the feed stub 22 and the feed network 3. For example, there may be a coupling gap between the feed stub 22 and the feed network 3. To be specific, feeding is performed in a non-contact manner. This can facilitate assembly of the feed network 3 in the antenna apparatus 100 and fitting with the feed stub 22, without an additional welding process, so that an assembly operation is simplified.

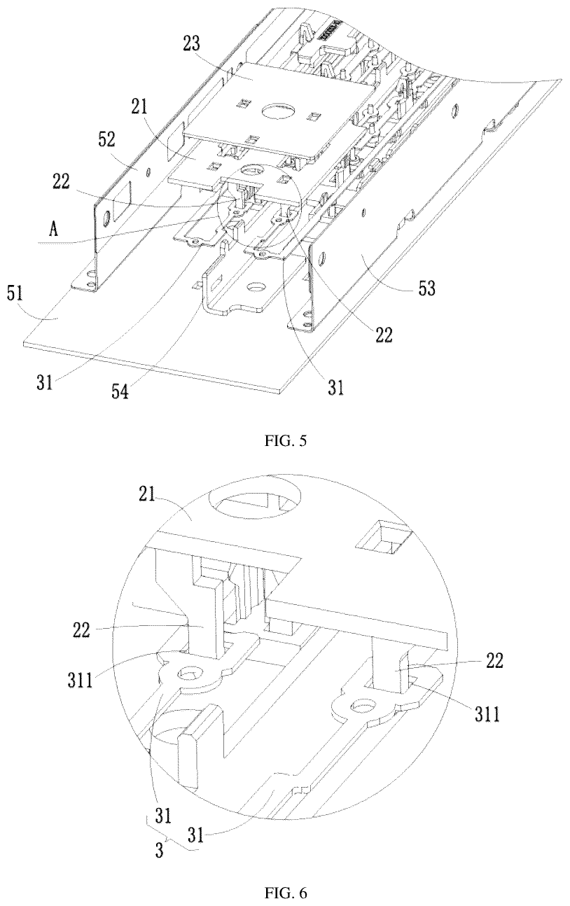

In an embodiment, FIG. 5 is a partial diagram of the antenna apparatus 100 (the support 4 and the reflection panel 1 are hidden) according to the first embodiment of this application. FIG. 6 is an enlarged view of a position A in FIG. 5. As shown in FIG. 6, the feed network 3 is provided with a second aperture 311, and the feed stub 22 passes through the second aperture 311. An end, away from the radiator 21, of the feed stub 22 may pass through the second aperture 311. For example, the feed stub 22 may be welded to an inner wall of the second aperture 311, to implement feeding through a direct electrical connection. For example, there may alternatively be a coupling gap between the feed stub 22 and an inner wall of the second aperture 311. During assembly, the feed stub 22 only needs to sequentially pass through the first aperture 11 of the reflection panel 1 and the second aperture 311 of the feed network 3, and the feed stub 22 does not need to be directly connected to the feed network 3 through a cable, a welding process, or the like. This simplifies an assembly operation, and also helps reduce a quantity of components, improve integration of the antenna apparatus 100, and implement a lightweight design of the antenna apparatus 100.

In an embodiment, as shown in FIG. 3, the antenna apparatus 100 further includes the support 4. The support 4 is made of an insulation material, and can support and fasten the feed network 3 and the radiating element 2. For example, the feed network 3 may be provided with a mounting hole, the support 4 may be provided with a protrusion, and the feed network 3 may be mounted and fastened to the support 4 through fitting between the mounting hole and the protrusion. For example, the feed network 3 may alternatively snap into the support 4. For example, the support 4 is provided with a groove structure, and a portion of the feed network 3 may snap into the groove, to mount and fasten the feed network 3. Similarly, the radiator 21 may also be connected to the support 4 in a manner similar to the manner of mounting the feed network 3, so that the support 4 reliably supports and fastens the radiator 21. In this way, the design of the support 4 can facilitate assembly of the feed network 3 and the radiating element 2, and can also ensure reliability of an overall structure of the antenna apparatus 100.

In an embodiment, as shown in FIG. 4, a third aperture 12 is provided on the reflection panel 1, and at least a portion of the support 4 passes through the third aperture 12 and is connected to the radiator 21. The third aperture 12 and the first aperture 11 may be two independent holes, or may be holes that are in communication, provided that the support 4 and the feed stub 22 can pass through the holes. The support 4 needs to support and fasten both the feed network 3 and the radiator 21 that are located on the two sides of the reflection panel 1. The third aperture 12 is provided on the reflection panel 1, so that at least a portion of the support 4 can pass through the third aperture 12, and some parts of the support 4 that are located on the two sides of the reflection panel 1 can be respectively connected to the feed network 3 and the radiator 21. In this way, both the feed network 3 and the radiator 21 are supported and fastened by the support 4. This facilitates an assembly operation, simplifies an overall structure of the antenna apparatus 100, and facilitates a lightweight and miniaturization design of the antenna apparatus 100.

In an embodiment, a gap is provided between the feed stub 22 and the first aperture 11. Since the reflection panel 1 is typically a metal plate, if the feed stub 22 comes into contact with the reflection panel 1, a short circuit occurs, and an electromagnetic wave cannot be normally radiated. Therefore, a gap is provided between the feed stub 22 and the first aperture 11, so that a short circuit can be avoided, and the feed network 3 and the radiator 21 that are located on the two sides of the reflection panel 1 can be electrically coupled after the feed stub 22 passes through the first aperture 11. This helps improve compactness of a structure of the antenna apparatus 100, and facilitates assembly.

In an embodiment, as shown in FIG. 2, the antenna apparatus 100 further includes a metal cavity 5, the reflection panel 1 is a top wall of the metal cavity 5, and the feed network 3 is disposed in the metal cavity 5. The metal cavity 5 can reduce energy loss. This helps transfer energy to the radiating element 2 through the metal cavity 5, to improve radiation performance, and also helps affect resonance distribution of the feed network 3, to improve transmission characteristics of the feed network 3. In addition, the reflection panel 1 may serve as a side wall of the metal cavity 5. In this way, radio frequency signals can be converged to a convergence point of the radiating element 2, to improve reception sensitivity for the radio frequency signals, and energy of the feed network 3 can be constrained by the formed metal cavity 5, to avoid energy leakage and loss and improve energy transfer quality.

In an embodiment, as shown in FIG. 3, the antenna apparatus 100 further includes a bottom wall 51, a first side wall 52, and a second side wall 53, and the reflection panel 1, the first side wall 52, the bottom wall 51, and the second side wall 53 are sequentially coupled head to tail, and enclose the metal cavity 5. Adjacent two of the reflection panel 1, the first side wall 52, the bottom wall 51, and the second side wall 53 may be directly welded, or may be connected through gap coupling, for example, connected through a connecting piece like a rivet, with a preset coupling gap retained by the connecting piece like a screw or the rivet. For connections between the reflection panel 1, the first side wall 52, the bottom wall 51, and the second side wall 53, one process is usually used for integration. However, in this manner, processing is difficult, costs are high, it is inconvenient to adjust relative positions between parts or replace structures, and it is inconvenient to adjust performance of the antenna apparatus 100. Therefore, in this embodiment, all of the reflection panel 1, the first side wall 52, the bottom wall 51, and the second side wall 53 may be independently processed and manufactured, and then connected through a welding process, a riveting process, or the like to form the metal cavity 5. This assembly manner is flexible, has a simple process, has low costs, and makes it easy to adjust relative positions between parts or replace related structures based on needed antenna radiation performance, to ensure that the antenna apparatus 100 achieves good radiation performance in different use environments.

In an embodiment, as described above, at least portions of the following are welded: the reflection panel 1, the first side wall 52, the bottom wall 51, and the second side wall 53. For example, two ends of the reflection panel 1 may be respectively welded to the first side wall 52 and the second side wall 53, or two ends of the bottom wall 51 are respectively welded to the first side wall 52 and the second side wall 53. Through welding, reliability of a connection between two welded mechanical parts can be ensured. Two components may be welded and fastened through a laser welding process. In an embodiment, at least portions of the following are connected through a connecting piece: the reflection panel 1, the first side wall 52, the bottom wall 51, and the second side wall 53, with coupling gaps defined therebetween. As described above, portions of adjacent components may be connected through a screw or a rivet, with a preset gap retained, to simplify a process and facilitate assembly.

As shown in FIG. 3, the reflection panel 1 may be in a “U” shape, to facilitate connections to the first side wall 52 and the second side wall 53, ensure accuracy of adjusting a coupling gap between the reflection panel 1 and an isolated ground 54, and ensure consistency of distances between the reflection panel 1 and different positions in the feed network 3.

In an embodiment, as shown in FIG. 3, the feed network 3 includes at least two feed sheets 31. The feed sheet 31 may be in a regular or irregular shape. Each feed sheet 31 may feed radiators 21 in a plurality of radiating elements 2. At least two feed stubs 22 are disposed. For example, there may be two or four feed stubs 22. For ease of description, in this embodiment, an example in which two feed sheets 31 are disposed is used for description. The radiator 21 generates one polarization through at least one feed stub 22, and the radiator 21 generates another polarization through at least another feed stub 22. Directions of the two polarizations may be perpendicular to each other. To be specific, one polarization is a −45° polarization, and the other polarization is a +45° polarization. In this way, a dual-polarized antenna is formed. The feed stub 22 that enables the radiator 21 to generate the one polarization is coupled to one of the feed sheets 31, and the feed stub 22 that enables the radiator 21 to generate the another polarization is coupled to another one of the feed sheets 31. Feeding phases of the two feed stubs 22 are different, so that the radiator 21 can generate dual polarizations. In an embodiment, both of the two feed sheets 31 are metal sheets, and are disposed in the metal cavity 5. The feed stub 22 may also be made of a metal material. The feed stub 22 may be directly welded to the feed sheet 31, or may be gap-coupled to the feed sheet 31 through the second aperture 311 on the feed sheet 31.

In an embodiment, as shown in FIG. 3, the antenna apparatus 100 further includes an isolated ground 54. The isolated ground 54 is disposed in the metal cavity 5, and two ends of the isolated ground 54 are respectively coupled to the reflection panel 1 and the bottom wall 51. The metal cavity 5 is divided into a first cavity 55 and a second cavity 56 by the isolated ground 54. A feed sheet 31 that enables the radiating element 2 to generate one polarization is located in the first cavity 55, and a feed sheet 31 that enables the radiating element 2 to generate another polarization is located in the second cavity 56. The isolated ground 54 is made of a metal material, to implement good isolation between the dual polarizations, and ensure that the antenna apparatus 100 achieves good radiation performance.

In an embodiment, the isolated ground 54 may be directly welded to the bottom wall 51 through a laser welding process, to ensure reliability of a connection between the isolated ground 54 and the bottom wall 51. In an embodiment, the isolated ground 54 may alternatively be riveted to the bottom wall 51 through a connecting piece like a screw or a rivet, and a preset coupling gap can be retained between the isolated ground 54 and the bottom wall 51 through the connecting piece like the screw or the staple, to implement an electrical connection between the isolated ground 54 and the bottom wall 51.

In an embodiment, the isolated ground 54, the bottom wall 51, the first side wall 52, and the second side wall 53 may be integrally formed, to ensure reliability of connections between the isolated ground 54, the bottom wall 51, the first side wall 52, and the second side wall 53. In addition, the reflection panel 1 may be welded to the first side wall 52 and the second side wall 53 through a welding process, or certainly may be fastened to the first side wall 52 and the second side wall 53 through a riveting process. After the reflection panel 1 is mounted, a specific gap is retained between the reflection panel 1 and the isolated ground 54, so that the reflection panel 1 and the isolated ground 54 form a gap coupling connection.

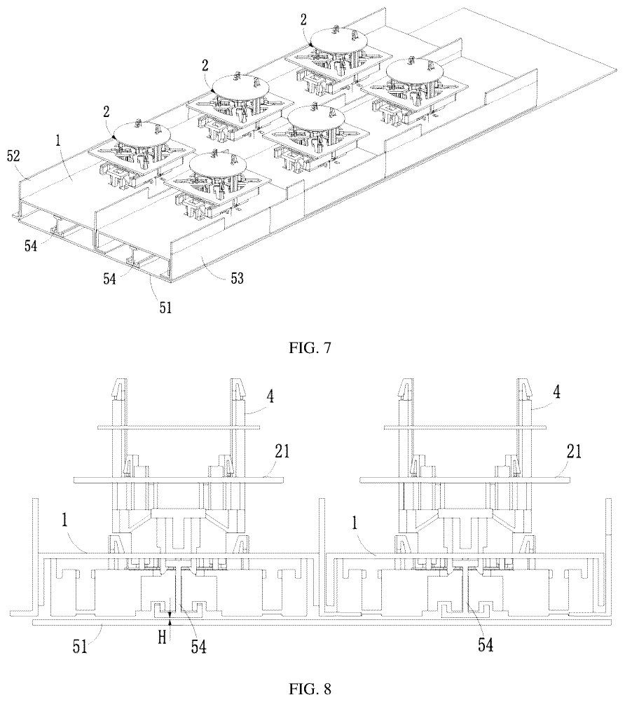

In an embodiment, FIG. 7 is a diagram of a structure of an antenna apparatus 100 according to a second embodiment of this application. FIG. 8 is a side view of the antenna apparatus 100 according to the second embodiment of this application. As shown in FIG. 7 and FIG. 8, there may also be coupling gaps H between two ends of an isolated ground 54 and a reflection panel 1 and a bottom wall 51 respectively. If the isolated ground 54 is directly connected to the bottom wall 51 or the reflection panel 1, a new frequency component is likely to appear due to poor contact between metals, causing interference and reception blocking. Therefore, in this embodiment, the isolated ground 54 may be separately processed, manufactured, and assembled. During assembly, the isolated ground 54 may be fastened to each of the reflection panel 1 and the bottom wall 51 through a connecting piece like a screw or a rivet, and a preset gap can be retained between the isolated ground 54 and each of the reflection panel 1 and the bottom wall 51 through the connecting piece like the screw or the rivet, to form a gap coupling connection, to avoid direct contact between metals, and ensure normal operation of the antenna apparatus 100.

In an embodiment, a width of a coupling gap between the isolated ground 54 and the reflection panel 1 and/or a width of a coupling gap between the isolated ground 54 and the bottom wall 51 may be less than 1 mm, to ensure effective energy transfer between the isolated ground 54 and the reflection panel 1 and/or between the isolated ground 54 and the bottom wall 51, and reduce loss.

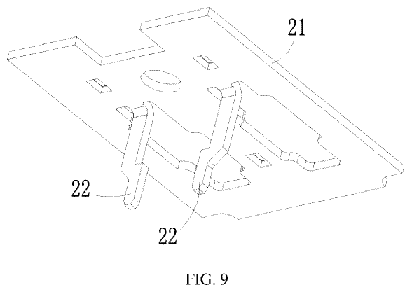

In an embodiment, FIG. 9 is a diagram of a connection between a radiator 21 and feed stubs 22 according to the first embodiment of this application. As shown in FIG. 9, the radiator 21 and two feed stubs 22 are integrally formed, to ensure reliability of the connection between the radiator 21 and the feed stubs 22, facilitate assembly, and reduce an assembly tolerance.

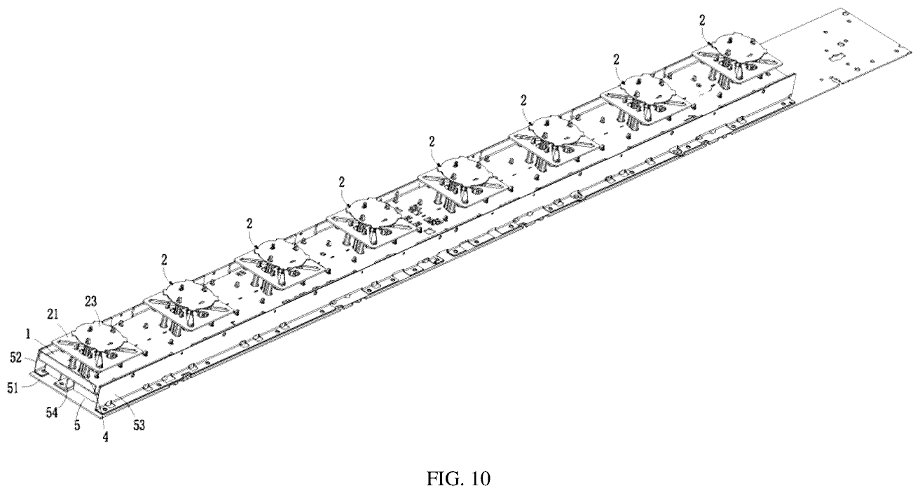

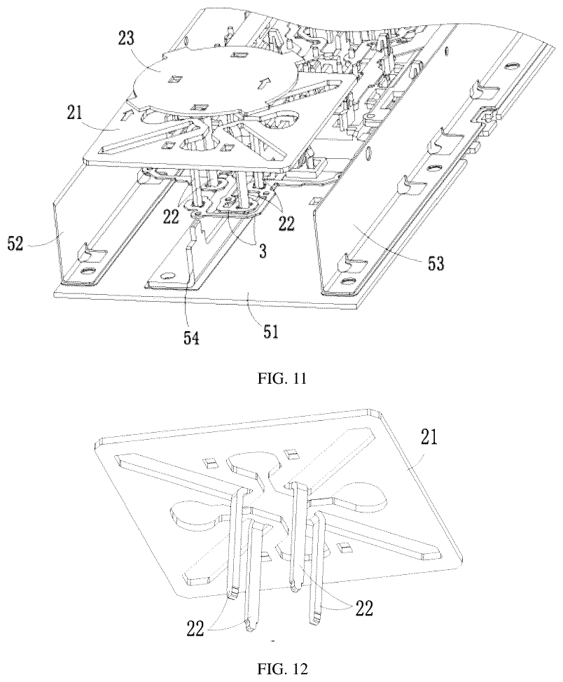

In an embodiment, FIG. 10 is a diagram of a structure of an antenna apparatus 100 according to a third embodiment of this application. FIG. 11 is a partial diagram of the antenna apparatus 100 (a support 4 and a reflection panel 1 are hidden) according to the third embodiment of this application. As shown in FIG. 11, four feed stubs 22 may be disposed, the four feed stubs 22 are respectively distributed in four corners of a rhombus pattern, two feed stubs 22 located on one diagonal line are coupled to one of the feed sheets 31, and two feed stubs 22 located on the other diagonal line are coupled to another one of the feed sheets 31. Two feed stubs 22 located on one diagonal line may enable a radiator 21 to generate one polarization, and two feed stubs 22 located on the other diagonal line may enable the radiator 21 to generate another polarization. With the four feed stubs 22 disposed, higher bandwidth can be achieved.

FIG. 12 is a diagram of a connection between a radiator 21 and feed stubs 22 according to the third embodiment of this application. As shown in FIG. 12, the radiator 21 and four feed stubs 22 are integrally formed, to ensure reliability of the connection between the radiator 21 and the feed stubs 22, facilitate assembly, and reduce an assembly tolerance.

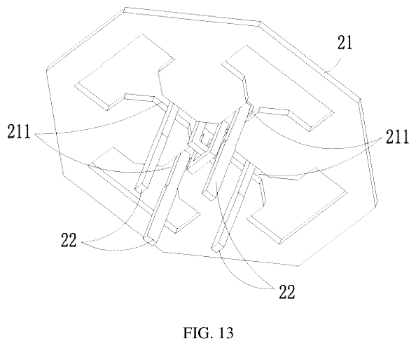

In an embodiment, FIG. 13 is a diagram of a connection between a radiator 21 and feed stubs 22 according to a fourth embodiment of this application. As shown in FIG. 13, slots 211 are provided on the radiator 21, the feed stubs 22 are coupled to the slots 211, and there are coupling gaps between the feed stubs 22 and inner walls of the slots 211. Compared with a design in which the radiator 21 and the feed stubs 22 are integrally formed, gap-coupling the feed stubs 22 to the slots 211 on the radiator 21 can achieve higher bandwidth. In addition, a new resonance point can be further introduced, to provide more operating modes.

In an embodiment, as shown in FIG. 3, the radiating element 2 further includes a parasitic stub 23, and the parasitic stub 23 is coupled to the radiator 21. The parasitic stub 23 may alternatively include a metal sheet, and there is a specific spacing between the parasitic stub 23 and the radiator 21. The parasitic stub 23 can improve radiation performance of the radiator 21 and increase bandwidth, and can also introduce new resonance, to provide more operating modes.

The foregoing descriptions are merely example embodiments of this application, and are not intended to limit this application. A person skilled in the art may make various modifications and variations to this application. Any modification, equivalent replacement, or improvement made without departing from the spirit and principle of this application shall fall within the protection scope of this application.

1. An antenna apparatus, comprising:
a reflection panel, wherein a first aperture is provided on the reflection panel;
a radiating element, wherein the radiating element comprises a radiator and a feed stub, the radiator is coupled to the feed stub, the radiator is disposed on one side of the reflection panel and is spaced apart from the reflection panel, and at least a portion of the feed stub passes through the first aperture; and
a feed network, disposed on a side, facing away from the radiating element, of the reflection panel and spaced apart from the reflection panel, wherein the feed network is coupled to the feed stub.

2. The antenna apparatus according to claim 1, further comprising a metal cavity, wherein the reflection panel is a top wall of the metal cavity, and the feed network is disposed in the metal cavity.

3. The antenna apparatus according to claim 2, further comprising a bottom wall, a first side wall, and a second side wall, wherein the reflection panel, the first side wall, the bottom wall, and the second side wall are sequentially coupled head to tail, and enclose the metal cavity.

4. The antenna apparatus according to claim 3, wherein at least portions of the following are welded: the reflection panel, the first side wall, the bottom wall, and the second side wall.

5. The antenna apparatus according to claim 3, wherein at least portions of the following are connected through a connecting piece: the reflection panel, the first side wall, the bottom wall, and the second side wall, with coupling gaps defined therebetween.

6. The antenna apparatus according to claim 3, wherein the feed network comprises at least two feed sheets;
at least two feed stubs are disposed, the radiator generates one polarization through at least one feed stub, and the radiator generates another polarization through at least another feed stub; and
the feed stub that enables the radiator to generate the one polarization is coupled to one of the feed sheets, and the feed stub that enables the radiator to generate the another polarization is coupled to another one of the feed sheets.

7. The antenna apparatus according to claim 6, further comprising an isolated ground, wherein the isolated ground is disposed in the metal cavity, two ends of the isolated ground are respectively coupled to the reflection panel and the bottom wall, the metal cavity is divided into a first cavity and a second cavity by the isolated ground, a feed sheet that enables the radiating element to generate one polarization is located in the first cavity, and a feed sheet that enables the radiating element to generate another polarization is located in the second cavity.

8. The antenna apparatus according to claim 7, wherein the isolated ground, the bottom wall, the first side wall, and the second side wall are integrally formed, and there is a coupling gap between the reflection panel and an end, away from the bottom wall, of the isolated ground.

9. The antenna apparatus according to claim 7, wherein there are coupling gaps between the two ends of the isolated ground and the reflection panel and the bottom wall respectively.

10. The antenna apparatus according to claim 9, wherein a width of a coupling gap between the isolated ground and the reflection panel and/or a width of a coupling gap between the isolated ground and the bottom wall are/is less than 1 mm.

11. The antenna apparatus according to claim 6, wherein four feed stubs are disposed, the four feed stubs are respectively distributed in four corners of a rhombus pattern, two feed stubs located on one diagonal line are coupled to one of the feed sheets, and two feed stubs located on the other diagonal line are coupled to another one of the feed sheets.

12. The antenna apparatus according to claim 1, wherein the feed network is provided with a second aperture, and the feed stub passes through the second aperture.

13. The antenna apparatus according to claim 12, wherein there is a coupling gap between the feed stub and the second aperture.

14. The antenna apparatus according to claim 1, wherein the radiator and the feed stub are integrally formed.

15. The antenna apparatus according to claim 1, wherein a slot is provided on the radiator, the feed stub is coupled to the slot, and there is a coupling gap between the feed stub and an inner wall of the slot.

16. The antenna apparatus according to claim 1, wherein there is a gap between the feed stub and the first aperture.

17. The antenna apparatus according to claim 1, wherein the radiating element further comprises a parasitic stub, and the parasitic stub is coupled to the radiator.

18. The antenna apparatus according to claim 1, further comprising a support, wherein the feed network is connected to the support; and
a third aperture is provided on the reflection panel, and at least a portion of the support passes through the third aperture and is connected to the radiator.

19. A base station antenna system, comprising the antenna apparatus which further comprises:
a reflection panel, wherein a first aperture is provided on the reflection panel;
a radiating element, wherein the radiating element comprises a radiator and a feed stub, the radiator is coupled to the feed stub, the radiator is disposed on one side of the reflection panel and is spaced apart from the reflection panel, and at least a portion of the feed stub passes through the first aperture; and
a feed network, disposed on a side, facing away from the radiating element, of the reflection panel and spaced apart from the reflection panel, wherein the feed network is coupled to the feed stub.

20. The base station antenna system according to claim 19, further comprising a metal cavity, wherein the reflection panel is a top wall of the metal cavity, and the feed network is disposed in the metal cavity.
